(19) United States
(12) Patent Application Publication
(10) Pub. No.: US 2015/0055995 A1
(43) Pub. Date: Feb. 26, 2015

(54) FIXING MEMBER, FIXING DEVICE USING THE FIXING MEMBER, AND IMAGE FORMING APPARATUS USING THE FIXING DEVICE

(71) Applicants: Yasuyuki Yamashita, Shizuoka (JP); Yuka Aoyama, Kanagawa (JP); Shinji Nohsho, Tokyo (JP)

(72) Inventors: Yasuyuki Yamashita, Shizuoka (JP); Yuka Aoyama, Kanagawa (JP); Shinji Nohsho, Tokyo (JP)

(21) Appl. No.: 14/450,497

(22) Filed: Aug. 4, 2014

(30) Foreign Application Priority Data
Aug. 20, 2013 (JP) 2013-170104

(51) Int. Cl. G03G 15/20

(52) U.S. Cl. CPC G03G 15/206
USPC 399/333

(57) ABSTRACT

A fixing member having a roller shape or a seamless belt shape for fixing toner is provided. The fixing member includes an elastic layer; an adhesive layer located overlying the elastic layer; and a release layer including a particulate material, which is arranged along the surface of the adhesive layer.

### CROSS-REFERENCE TO RELATED APPLICATIONS

This patent application is based on and claims priority pursuant to 35 U.S.C. §119 to Japanese Patent Application No. 2013-170104 filed on Aug. 20, 2013 in the Japan Patent Office, the entire disclosure of which is hereby incorporated by reference herein.

### BACKGROUND

1. Technical Field

This disclosure relates to a fixing member, and to a fixing device using the fixing member. In addition, this disclosure relates to an image forming apparatus using the fixing device.

2. Description of the Related Art

Conventional electrophotographic image forming apparatus such as copiers, printers and facsimiles typically include a rotatable photoreceptor drum, and perform an image forming operation in which the photosensitive layer of the photoreceptor drum is evenly charged; the charged photoreceptor drum is exposed to a laser beam emitted from a laser scanning unit to form an electrostatic latent image on the photoreceptor drum; the electrostatic latent image is developed with a developer including a toner to form a toner image on the photoreceptor drum; the toner image is transferred onto a recording medium; and the recording medium bearing the toner image is passed through a fixing device such as a pair of fixing rollers to fix the toner image to the recording medium.

Full color copiers and full color laser printers typically use four color toners such as magenta (M), cyan (C), yellow (Y) and black (K) toners. When a color toner image formed by using such four color toners is thermally fixed, the four color toners have to be mixed while melted in the fixing operation. Therefore, the color toners have to have a low melting point so as to be easily melted when heated. In addition, the fixing member used for the fixing operation has to melt plural color toners on the surface thereof in such a manner that the color toners are melted and encompassed with each other to homogeneously mix the color toners.

In a thermal fixing method using such a fixing member as mentioned above, a melted toner image on a recording medium (such as paper sheets) is contacted with the fixing member, and therefore a layer, which includes a material having good releasability such as fluorine-containing resins and which has a thickness of from 15 μm to 30 μm, is typically formed on the surface of the fixing member.

Since a fixing roller serving as a fixing member is directly contacted with the surface of a recording medium bearing a toner image, an offset phenomenon such that part of the toner image on the recording medium is adhered to the surface of the fixing roller, and the toner adhered to the fixing roller is transferred again to the recording medium, resulting in formation of an abnormal image (soiling of background of image with toner) is easily caused.

In attempting to prevent occurrence of the offset phenomenon, a fixing device in which an offset preventing cover layer including a material having high releasability (i.e., non-adhesive material) such as fluorine-containing resins (e.g., polytetrafluoroethylene resins (PTFE)) and silicone rubbers is formed on the peripheral surface of a fixing roller has been conventionally used.

However, since fluorine containing resins are resins, the fluorine containing resins have a high hardness. When a material having a high hardness is used for the offset preventing cover layer of a fixing roller and a paper sheet is used as the recording medium, the cover layer cannot be well contacted with recessed portions of the paper sheet (i.e., the cover layer has poor adhesion) when a toner image on the paper sheet is fixed by the fixing roller upon application of heat and pressure thereto, thereby causing a problem in that high quality images cannot be produced.

In attempting to solve the problem, a fixing member having an elastic layer on the surface thereof has been used. Since a fixing member having such an elastic layer thereon has improved adhesion, high quality color images can be produced. However, such a fixing member has relatively poor durability and abrasion resistance compared with a fixing member having an outermost layer including a fluorine-containing resin. In addition, when a separation pick is used for separating a recording medium sheet from the elastic layer of the fixing member, the surface of the elastic layer is easily damaged, and a toner image is defectively fixed on the recording medium, resulting in formation of an abnormal image.

It is well known to use a composition including a silicone rubber and a large amount of particulate silica or alumina for the elastic layer in attempting to enhance the abrasion resistance of the elastic layer. However, such a silicone composition typically has a high hardness (rubber hardness), and therefore the elastic layer cannot have elasticity sufficient for producing high quality images.

In attempting to solve the problem, a technique in that a rubber having a low cross-linkage density (i.e., a rubber having a low hardness) is used for the elastic layer is proposed. However, such an elastic layer has a low mechanical strength (rubber strength), and therefore a problem in that an inorganic filler included in the elastic layer is released from the layer, resulting in deterioration of the abrasion resistance of the elastic layer is easily caused. In addition, since the released inorganic filler serves as an abrading material, abrasion of the elastic layer is accelerated.

### SUMMARY

As an aspect of this disclosure, a fixing member having a roller shape or a seamless belt shape for fixing toner is provided which includes at least an elastic layer, an adhesive layer located overlying the elastic layer, and a release layer including a particulate material, which is arranged along a surface of the adhesive layer (i.e., along the surface of the fixing member).

As another aspect of this disclosure, a fixing device is provided which includes the fixing member mentioned above, and a counter member opposed to the fixing member. The fixing device applies heat and pressure to a recording medium, which bears a toner image thereon and which passes between the fixing member and the counter member, to fix the toner image to the recording medium.

As another aspect of this disclosure, an image forming apparatus is provided which includes an electrostatic latent image carrier; an electrostatic latent image forming device to form an electrostatic latent image on the electrostatic latent image carrier; a developing device to develop the electrostatic latent image with a developer including a toner to form a toner image on the electrostatic latent image carrier; a transferring device to transfer the toner image onto a recording medium; and the above-mentioned fixing device to fix the toner image to the recording medium.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1A is a schematic view illustrating an image forming apparatus using a fixing device including a fixing member according to an embodiment;

FIG. 1B is a schematic view illustrating another fixing device including a fixing member according to an embodiment;

FIG. 2A is a schematic cross-sectional view illustrating an example of the fixing member;

FIG. 2B is a schematic cross-sectional view illustrating another example of the fixing member;

FIG. 3 is a schematic view illustrating a method for forming a release layer on an adhesive layer;

FIG. 4 is a schematic cross-sectional view illustrating an example of the release layer while describing the embedding rate of a particulate material;

FIG. 5 is a schematic view for describing the shape factor SF1 of a particulate material; and

FIG. 6 is a schematic cross-sectional view illustrating another example of the release layer.

### DETAILED DESCRIPTION

The object of this disclosure is to provide a fixing member, which has so good adhesion to a recording medium having convex and concave that high quality images having high glossiness can be produced and which can produce high quality images with hardly forming an offset abnormal image by reducing the amount of residual toner remaining on the surface of the fixing member. Namely, the object of this disclosure is to provide a fixing member capable of stably fixing an unfixed toner image to a recording medium, thereby producing high quality fixed images over a long period of time.

As a result of the present inventors' diligent investigation, it is found that the above-mentioned object can be attained by a fixing member which includes at least an elastic layer, an adhesive layer located overlying the elastic layer, and a release layer including a particulate material, which is arranged in a surface direction (i.e., along the surface of the adhesive layer). In this regard, “overlying” can include direct contact and allow for one or more intermediate layers.

The fixing member of this disclosure will be described.

The fixing member of this disclosure includes at least an elastic layer, an adhesive layer located overlying the elastic layer, and a release layer, which serves as an outermost layer and which is located on the adhesive layer. The release layer is a particle layer in which a particulate material is arranged along the surface of the adhesive layer (i.e., along the surface of the fixing member). The fixing member can further include another layer such as a base layer having a high physical strength and located below the elastic layer, and a primer layer located between the base layer and the elastic layer.

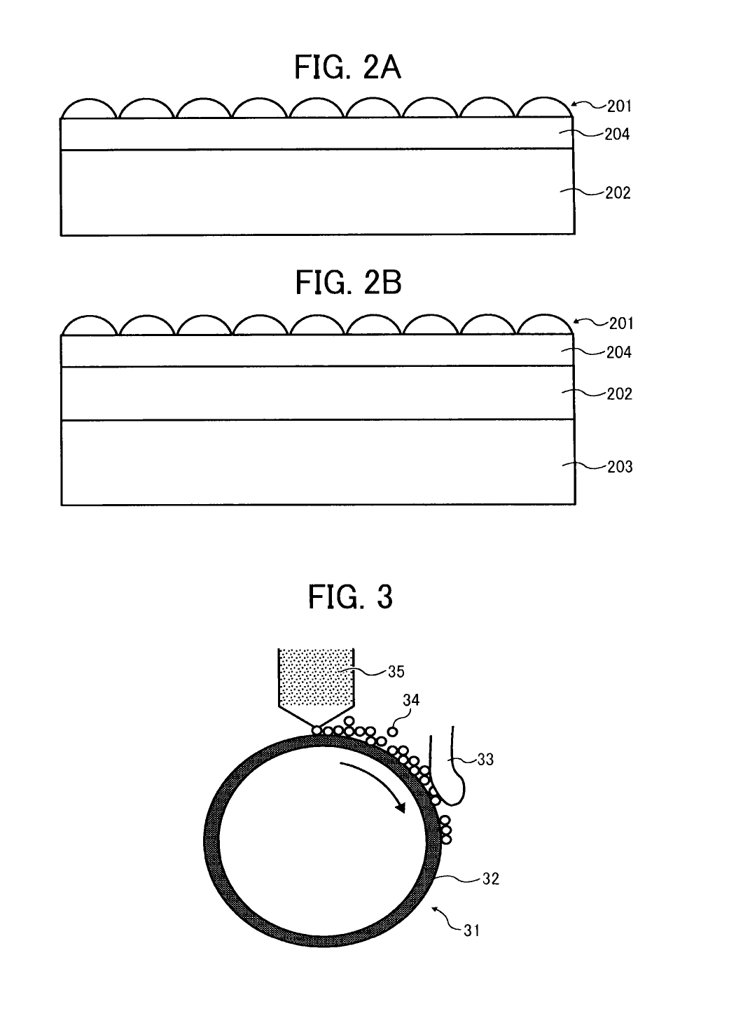

FIG. 2A is a schematic cross-sectional view illustrating an example of the fixing member of this disclosure. The fixing member illustrated in FIG. 2A has a multi-layered structure such that an adhesive layer 204 is located on an elastic layer 202, and a release layer 201 is located on the adhesive layer 204 as an outermost layer.

FIG. 2B is a schematic cross-sectional view illustrating another example of the fixing member. The fixing member illustrated in FIG. 2B has another multi-layered structure such that the elastic layer 202 (serving as an intermediate layer) is located on a base layer 203, the adhesive layer 204 is located on the elastic layer 202, and the release layer 201 (serving as an outermost layer) is located on the adhesive layer 204.

Next, each of the layers of the fixing member will be described in detail.

### 1. Base Layer

The fixing member optionally includes a base layer, which is located below the elastic layer. The shape, structure, thickness, constitutional material, and size of the base layer are not particularly limited, and are properly determined depending on the purpose of the fixing member.

Specific examples of the shape of the base layer include planar shape, belt shape, and cylindrical shape.

Specific examples of the structure of the base layer include single-layered structure and multi-layered structure.

Materials having good heat resistance such as resins and metals are preferably used as the constitutional material of the base layer. Specific examples of such resins include polyimide, polyamideimide, polyether ether ketone (PEEK), polyethersulfone (PES), polyphenylene sulfide (PPS), and fluorine-containing resins. A particulate magnetic and electroconductive material can be included in the resins. Specifically, a particulate magnetic and electroconductive material is mixed with a resin having a varnish state, and the mixture is subjected to a dispersing treatment using a dispersing machine such as roll mills, sand mills, and centrifugal dispersing and defoaming machines. The resultant dispersion is diluted with a solvent so as to have a proper viscosity, followed by molding using a proper die so that the molded article has a proper thickness.

Specific examples of the metals for use in the base layer include nickel, iron, chromium, and metal alloys of two or more of these metals. The metal constituting the base layer may produce heat by itself.

The thickness of the base layer is preferably from 30 μm to 500 μm, and more preferably from 50 μm to 150 μm, from the viewpoints of heat capacity and mechanical strength of the base layer.

When a metal is used for the base layer of a belt-shaped fixing member, the thickness of the base layer is preferably not greater than 100 μm so that the belt-shaped fixing member can be satisfactorily bent.

When the above-mentioned metals are used for the base layer, the base layer can have a desired Curie point by adjusting the added amounts of metals and the processing conditions. By forming a base layer (exothermic layer) which has a Curie point near the fixing temperature, the base layer (exothermic layer) can be properly heated to a temperature near the fixing temperature by electromagnetic induction without excessive temperature rise.

The fixing member does not necessarily include the base layer (i.e., the fixing member optionally include the base layer).

### 2. Elastic Layer

The elastic layer is not particularly limited as long as the layer is constituted of an elastic material having good heat resistance. Among various heat resistant elastic materials, heat resistant rubbers are preferable. Specific examples thereof include natural rubbers, styrene-butadiene rubbers (SBR), butyl rubbers, chloroprene rubbers, nitrile rubbers, acrylic rubbers, urethane rubbers, silicone rubbers, fluorosilicone rubbers, fluorine-containing rubbers, and fluorine-containing elastomers.

Among these, elastic rubbers having a siloxane bond are preferable because of having good heat resistance, and silicone rubbers, fluorosilicone rubbers, fluorine-containing rubbers, and fluorine-containing elastomers are more preferable, and silicone rubbers and fluorosilicone rubbers are even more preferable because of having a good combination of heat resistance, wettability against the adhesive layer, and cost.

The method for forming the elastic layer is not particularly limited, and specific examples thereof include blade coating methods, roll coating methods, and die coating methods.

The thickness of the elastic layer is not particularly limited, but is preferably from 50 μm to 500 μm. When the thickness of the elastic layer is less than 50 μm, the adhesion of the fixing member to convex and concave of a recording medium deteriorates, and therefore it often become unable to produce high quality images. In contrast, when the thickness is greater than 500 μm, it takes time until the fixing member stores heat necessary for fixing toner images, resulting in deterioration of convenience of the fixing member.

### 3. Adhesive Layer

The adhesive layer is formed overlying the elastic layer to prevent releasing of particles from the release layer, which is formed on the adhesive layer, even when a strong force is applied to the release layer.

The material constituting the adhesive layer is not particularly limited as long as the resultant adhesive layer can hold the particle layer (release layer). However, the adhesive layer is preferably constituted of a rubber-like elastic material, and more preferably an elastic material having heat resistance of not lower than 200° C. so that the fixing member can be used without any problem. Among such rubber-like elastic materials, fluorocarbon siloxane rubbers are preferable, and fluorocarbon siloxane rubbers prepared by subjecting a fluorocarbon siloxane rubber composition to a hardening heat treatment are more preferable.

When the adhesive layer is constituted of a fluorocarbon siloxane rubber, particles of the release layer can be easily embedded into the adhesive layer, and the contact area of the particles with the adhesive layer can be increased. Therefore, even when an external force is applied to the release layer, the particles of the release layer are hardly released from the release layer.

Silicone rubbers, which are preferably used for the elastic layer, have a relatively low cost compared to fluorocarbon siloxane rubbers. However, the range of the hardening conditions, in which silicone rubbers can be hardened to prepare an adhesive layer capable of satisfactorily holding particles of the release layer, is very narrow. Namely, it is hard for silicone rubbers to form an adhesive layer, which can prevent releasing of particles from the release layer (i.e., it is hard for the elastic layer including a silicone rubber to prevent releasing of particles from the release layer if the adhesive layer is not formed). Therefore, by forming an adhesive layer, which has good adhesiveness to particles of the release layer, on the elastic layer, the particles of the release layer can be satisfactorily held by the adhesive layer even when the silicone rubber of the elastic layer is hardened under normal conditions. When a fluorocarbon siloxane rubber is used for the elastic layer, costs (material costs) of the fixing member increase.

The thickness of the adhesive layer is not particularly limited as long as the adhesive layer can satisfactorily hold particles of the release layer, but is preferable from lum to 100 μm.

The fluorocarbon siloxane rubber, which is used for the adhesive layer and which can be prepared by using a fluorocarbon siloxane rubber composition, preferably has a perfluoroalkylether structure and/or a perfluoroalkyl structure in the main chain thereof.

In this regard, the fluorocarbon siloxane rubber composition includes at least the following three components (A), (B) and (C).
(A) A fluorocarbon polymer, which has a fluorocarbon siloxane unit having the following formula (1) as a repeat unit and which has an unsaturated aliphatic group.

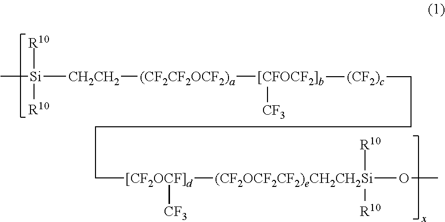

In formula (1), R¹⁰ represents a substituted or unsubstituted monovalent hydrocarbon group, x is an integer of not less than 1, each of a and e is 0 or 1, each of b and d is an integer of from 1 to 4, and c is 0 or an integer of from 1 to 8.
(B) An organopolysiloxane and/or a fluorocarbon siloxane, which includes two or more silylidyne groups (≡SiH) in one molecule, wherein the molar ratio (S/A) of the silylidyne groups (S) to the unsaturated aliphatic groups (A) included in the fluorocarbon polymer is from 1 to 4.
(C) Catalyst.

The catalyst is not particularly limited as long as the catalyst can accelerate the hardening reaction of the component (A) with the component (B) mentioned above, and specific examples thereof include platinum catalysts. Such a catalyst is added in an amount such that the hardening reaction of the component (A) with the component (B) can be accelerated.

Specific examples of marketed products of such a fluorocarbon siloxane rubber composition include SIFEL Series from Shin-Etsu Chemical Co., Ltd.

### 4. Release Layer

The release layer, which is an outermost layer of the fixing member, is preferably formed on the adhesive layer.

The release layer has a structure such that a particulate material is arranged along the surface of the adhesive layer (fixing member).

The particulate material is not particularly limited, and for example, glass, fluorine-containing resins, silicone resins, titanium dioxide, calcium carbonate, manganese oxide, aluminum oxide, and polyimide resins are preferably used because particles thereof can be easily arranged along the surface of the adhesive layer.

The particulate material preferably has a spherical form because spherical particles are easy to handle. It is preferable that the particulate material has a volume average particle diameter of from 0.1 μm to 10.0 μm, and more preferably from 1.0 μm to 5.0 μm while having a sharp particle diameter distribution. When the volume average particle diameter is less than 0.1 μm, it is hard to impart good releasability to the release layer. In contrast, when the volume average particle diameter is greater than 10.0 μm, the surface roughness of the release layer increases, thereby causing a problem in that the fixed image has low glossiness due to increase of the surface roughness of the fixed image. In addition, since the interval between two adjacent particles of the release layer increases, the releasability of the release layer tends to deteriorate.

The volume average particle diameter of a particulate material can be measured by a laser scattering particle size distribution analyzer. Specific examples of such an analyzer include E-SPART ANALYZER from HOSOKAWA MICRON CORPORATION. The measuring method is disclosed, for example, in JP-2002-278326-A. The abstract of the measuring method is the following.

Specifically, the instrument, E-SPART ANALYZER, uses a measuring method using a double beam frequency shift laser Doppler speed meter and an elastic wave to perturb movement of a particle in an electrostatic field. In the method, a particulate material set on a glass plate is blown off so as to fly in an electric field, and movement of the particles of the particulate material is observed to determine the volume average particle diameter of the particulate material. The number of particles of the sample (particulate material) is generally 3,000.

It is preferable that the particulate material is dispersed in the release layer without aggregate (i.e., the particulate material is mono-dispersed while separated from each other). When the particulate material is not mono-dispersed, two or more particles are overlaid in the release layer, and therefore it becomes hard to arrange the particulate material along the surface of the adhesive layer. As illustrated in FIGS. 2A and 2B, the release layer preferably achieves a single layer structure such that spherical particles are arranged along the surface of the adhesive layer without aggregate of the particles.

Next, an example of the method for forming the release layer will be described.

As illustrated in FIG. 3, the method uses a powder applicator 35 and a pressing member 33. Specifically, while a fixing member 31 having an adhesive layer 32 thereon is rotated, the powder applicator 35 applies particles of a particulate material 34 to the surface of the adhesive layer 32 so that the particles are evenly sprinkled on the surface of the adhesive layer 32. The sprinkled particles are pressed (smoothed) by the pressing member 33 at a certain pressure. In this regard, the pressing member 33 embeds the particles to the adhesive layer 32 while removing excessive particles from the surface of the particle layer (release layer).

Since a monodisperse particulate material is used, such a single-particle layer as illustrated in FIGS. 2A and 2B can be formed by using a simple method including smoothing particles using a simple pressing member.

After formation of the particle layer, the layer is heated for a predetermined time at a predetermined temperature while rotating the fixing member 31 to form a release layer on the surface of the fixing member.

In the fixing member of this disclosure, the particulate material constituting the release layer is preferably embedded into the lower layer (adhesive layer). The embedding rate of the particulate material is preferably is greater than 50% and less than 100%, and more preferably not greater than 90%. When the embedding rate is not greater than 50%, the particulate material constituting the release layer tends to be easily released from the fixing member when the fixing member is used for a long period of time in an electrophotographic image forming apparatus, resulting in deterioration of durability of the fixing member. In contrast, when the embedding rate is 100%, the releasability of the release layer deteriorates.

Adjustment of the embedding rate can be performed, for example, by adjusting the pressing force of the pressing member. For example, by controlling the pressing force in a range of from 1 mN/cm to 1,000 mN/cm, the embedding rate can be controlled in a range of from greater than 50% and not greater than 90%.

When a monodisperse particulate material is used, a release layer in which the particulate material is arranged along the surface of the fixing member (adhesive layer) can be easily formed by directly applying the particulate material on the lower layer (adhesive layer) and then smoothing the particulate material.

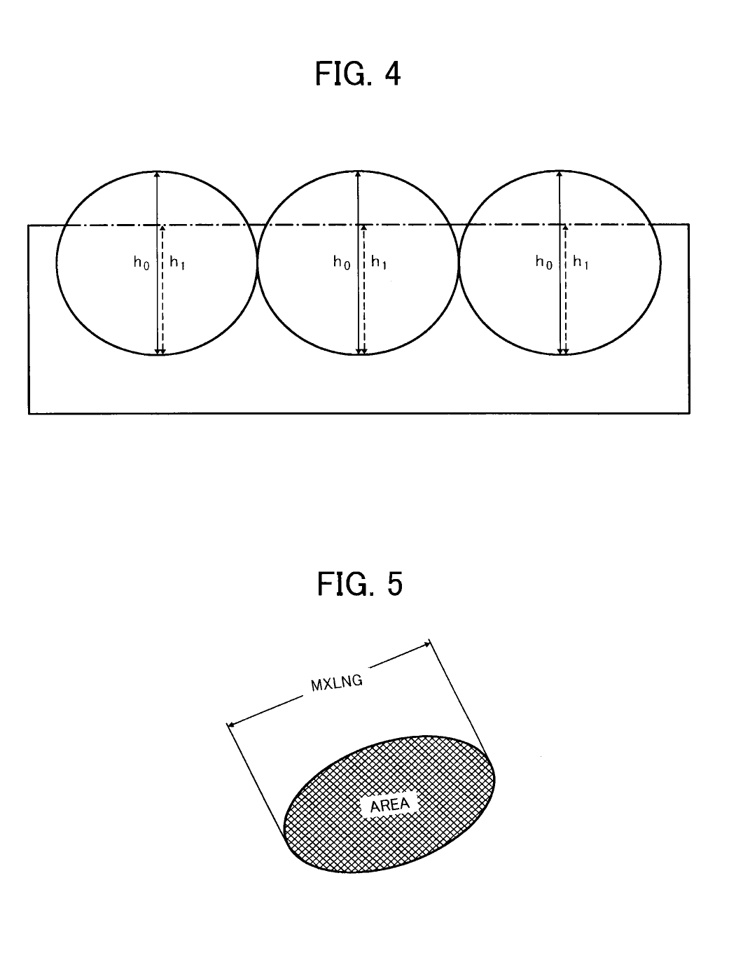

Next, the embedding rate will be described by reference to FIG. 4.

FIG. 4 is an enlarged view of the release layer illustrated in FIG. 2A or 2B. As illustrated in FIG. 4, part of the particulate material constituting the release layer is embedded into the lower layer (adhesive layer). In this regard, the particulate material illustrated in FIG. 4 has an embedding rate of h1/h0, wherein h0 represents the diameter of the particulate material, and h1 represents the depth of the embedded portion of the particulate material. The embedding rate h1/h0 preferably satisfies the following relationship:

0.5<h1/h0≦0.9.

In order to fully produce the effect of this disclosure, it is preferable that the above-mentioned relationship is satisfied.

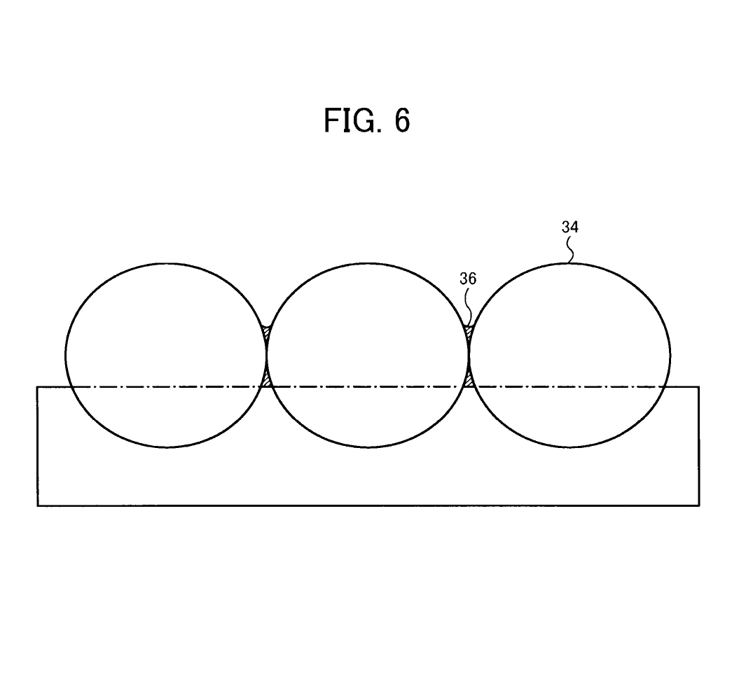

FIG. 6 illustrates another example of the release layer of the fixing member of this disclosure. In the release layer illustrated in FIG. 6, particles 34 of the release layer are bonded with a binder 36 such as binder resins.

Next, the circularity of a particulate material will be described.

FIG. 5 is a schematic view for use in describing a shape factor SF1 of a particulate material.

The shape factor SF1 represents roundness of a particle, and is represented by the following equation (1):

SF1={(MXLNG)²/AREA}×(100π/4) (1),

wherein MXLNG represents the maximum length of a projected image of a particle projected on a two-dimensional plane, and ARE represents the area of the projected image.

When the SF1 of the particulate material constituting the release layer is from 100 to 150, the particulate material can be easily arranged along the surface of the fixing member, i.e., a good release layer can be formed on the adhesive layer, resulting in production of the effect of this disclosure.

Next, the fixing device of this disclosure will be described.

The fixing device of this disclosure includes the fixing member of this disclosure mentioned above, and a counter member opposed to the fixing member. The fixing device applies heat and pressure to a recoding medium, which bears a toner image thereon and which passes between the fixing member and the counter member, to fix the toner image to the recording medium. The fixing device can optionally include another member.

The fixing member of the fixing device is, for example, a seamless fixing belt or a fixing roller. The seamless fixing belt is supported while tightly stretched by a support roller and an auxiliary fixing roller.

By using the fixing member for the fixing device, durability and reliability of the fixing device can be enhanced.

Next, the image forming apparatus of this disclosure will be described.

The image forming apparatus of this disclosure includes an electrostatic latent image carrier; an electrostatic latent image forming device to form an electrostatic latent image on a surface of the electrostatic latent image carrier; a developing device to develop the electrostatic latent image with a developer including a toner to form a visible image (toner image) on the surface of the electrostatic latent image carrier; a transferring device to transfer the visible image to a recording medium; and the fixing device mentioned above to fix the visible image to the recording medium. The image forming apparatus can includes another device such as dischargers, cleaners, recycling devices, and controllers.

The electrostatic latent image carrier (hereinafter sometimes referred to as a photoreceptor or an image carrier) is not particularly limited with respect to constitutional material, shape, structure and size, and any known image carriers can be used. Among various image carriers, drum-shaped image carriers are preferably used. Specific examples of the constitutional material include inorganic photoreceptors such as amorphous silicon and selenium, and organic photoreceptors such as phthalopolymethyne. Among these, amorphous silicon is preferable because of having a relatively long life.

The electrostatic latent image forming device is, for example, a combination of a charger to evenly charge a surface of the above-mentioned electrostatic latent image carrier and an irradiator to irradiate the charged surface of the electrostatic latent image carrier with light modulated by image information. In this regard, charging can be performed, for example, by applying a voltage to the surface of the electrostatic latent image carrier with a charger.

Specific examples of the charger include known contact chargers including an electroconductive or semi-electroconductive roller, brush, film or blade; known non-contact chargers utilizing corona discharge such as corotrons and scorotrons; etc.

Irradiation can be performed, for example, by irradiating a surface of the electrostatic latent image carrier with light modulated by image information using an irradiator.

The irradiator is not particularly limited as long as the irradiator can irradiate the charged surface of the electrostatic latent image carrier with light modulated by image information. Specific examples of the irradiator include optical systems for use in copiers, rod lens arrays, laser optical systems, optical systems using a liquid crystal shutter, etc.

The irradiator can irradiate the charged surface of the electrostatic latent image carrier from the front side or the backside of the electrostatic latent image carrier.

The developing device is not particularly limited as long as the device can develop an electrostatic latent image on the surface of the electrostatic latent image carrier using a toner or a developer. For example, developing device capable of applying a toner or a developer to an electrostatic latent image in a contact or non-contact manner can be used.

The developing device may be a dry developing device or a wet developing device. In addition, the developing device may be a monochromatic developing device or a multi-color developing device. Among various developing devices, developing devices including an agitator to frictionally agitate a toner or a developer to charge the toner or developer, and a rotatable magnetic roller are preferable.

In such developing devices, a toner and a carrier are mixed while agitated by the agitator, and thereby the toner is frictionally charged. The carrier and the charged toner are supported by the magnetic roller while erected, resulting in formation of a magnetic brush on the magnetic roller.

Since the magnetic roller is arranged in the vicinity of the electrostatic latent image carrier, part of the toner in the magnetic brush formed on the magnetic roller is transferred to the surface of the electrostatic latent image carrier by an electric attractive force, thereby developing the electrostatic latent image with the toner, resulting in formation of a visible image (toner image) on the surface of the electrostatic latent image carrier.

The developer used for the developing device is a developer including a toner (such as the toner mentioned above), which may be a one-component developer consisting essentially of a toner or a two-component developer including a toner and a carrier.

The transferring device is preferably a transferring device including a primary transferring member to transfer one or more visible images (toner images) from the electrostatic latent image carrier to an intermediate transfer medium to form a (combined) toner image thereon, and a secondary transferring member to transfer the (combined) toner image to a recording medium.

The intermediate transfer medium is not particularly limited, and for example, transfer belts can be used.

The transferring device (and the primary transferring member and the secondary transferring member) preferably includes at least a transfer member to subject the formed visible image to separation charging so that the visible image can be transferred to a recording medium. Specific examples of such a transfer member include corona transfer members, transfer belts, transfer rollers, pressure transfer rollers, adhesive transfer members, etc. The number of the transferring device is not limited, and one or more transferring devices can be used.

The recording medium is not particularly limited, and known recording media such as recording papers can be used.

The fixing device is a device to fix the visible image to the recording medium. The fixing device may perform the fixing operation whenever a visible image is transferred to the recording medium or after plural visible images (such as a combined color toner image) are transferred to the recording medium. The above-mentioned fixing device, which uses the fixing member of this disclosure, is used for the fixing device.

The discharger optionally used for the image forming apparatus is not particularly limited as long as the discharger can apply a discharge bias to the electrostatic latent image carrier, and any known discharges such as discharging lamps can be used therefor.

The cleaner optionally used for the image forming apparatus is not particularly limited as long as the cleaner can remove toner particles remaining on the electrostatic latent image carrier even after the toner image is transferred, and any known cleaners can be used therefor. Specific examples of such cleaners include magnetic brush cleaners, electrostatic brush cleaners, magnetic roller cleaners, blade cleaners, brush cleaners, web cleaners, etc.

The recycling device optionally used for the image forming apparatus is not particularly limited as long as the device can recycle the toner collected by the cleaner to use again the toner for development, and for example known powder feeding devices can be used therefor.

The controller is not particularly limited as long as the controller can control operations of the above-mentioned devices of the image forming apparatus. Specific examples of the controller include sequencers and computers.

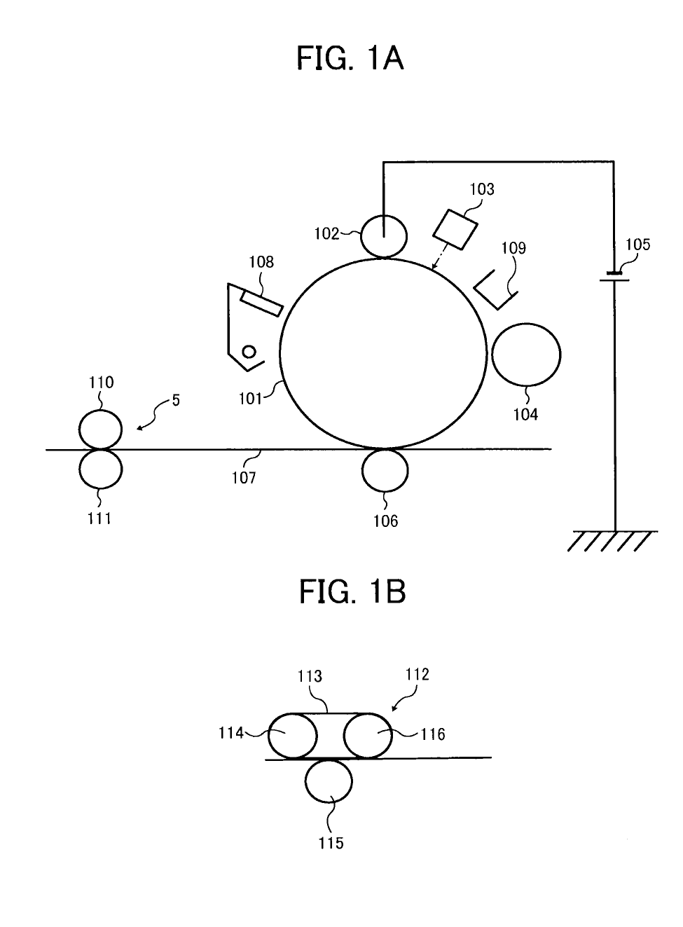

FIG. 1A is a schematic view illustrating a main portion of an example of the image forming apparatus of this disclosure, i.e., an image forming section including a photoreceptor drum 101 serving as an electrostatic latent image carrier, and a fixing device 5.

The image forming process of the electrophotographic image forming apparatus illustrated in FIG. 1A is as follows. Specifically, after the photoreceptor drum 101 is rotated and the photosensitive layer of the photoreceptor drum is uniformly charged by a charging roller 102, the charged photosensitive layer is exposed to a laser beam emitted by a laser scanning unit 103 serving as an irradiator, and thereby an electrostatic latent image is formed on the photoreceptor drum 101. In this regard, the combination of the charging roller 102 and the laser scanning unit 103 serves as an electrostatic latent image forming device. The electrostatic latent image is developed by a developing device including a developing roller 104 using a developer including a toner to form a toner image on the photoreceptor drum 101. The toner image is transferred to a recording medium 107 by a transfer roller 106 serving as a transferring device, and the toner image is fixed to the recording medium by a fixing device 5 upon application of heat and pressure thereto, resulting in formation of an image. After the toner image on the photoreceptor drum 101 is transferred to the recording medium 107, the surface of the photoreceptor drum is cleaned by a cleaner 108 so that the photoreceptor drum is ready for the next image forming operation.

In FIG. 1A, numerals 105 and 109 denote a power source to apply a voltage to the charging roller 102, and a surface potential meter to measure the surface potential of the photoreceptor drum 101, respectively.

The fixing device 5 includes a heat fixing roller 110, which serves as the fixing member of this disclosure, and a pressure roller 111, which serves as a counter member of the fixing device of this disclosure.

The heat fixing roller 110 includes a metal cylinder, and a heater (such as a halogen lamp) arranged inside the metal cylinder along the axis of the metal cylinder to heat the heat fixing roller from inside by radiation heat. The heater is not shown in FIG. 1A.

The pressure roller 111 is arranged so as to be parallel to the heat fixing roller 110. The recording medium 107 bearing the toner image thereon passes between the heat fixing roller 110 and the pressure roller 111, and thereby the toner image is softened by heat from the heat fixing roller 110. In addition, since the toner image is pressed by the pressure roller 111 and the heat fixing roller 110, the toner image is fixed to the recording medium 107.

FIG. 1B illustrates another example of the fixing device of this disclosure.

A fixing device 112 illustrated in FIG. 1B includes a fixing belt 113, which serves as the fixing member of this disclosure and which is rotated and heated while tightly stretched by a fixing roller 114 and a heat roller 116; and a pressure roller 115, which serves as a counter member.

The image forming apparatus of this disclosure uses the fixing device of this disclosure, which has a good combination of durability and reliability, and therefore the image forming apparatus can be preferably used for electrophotographic copiers, facsimiles, and laser beam printers.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Initially, a primer for silicone (PRIMER No. 4 from Shin-Etsu Chemical Co., Ltd.) was applied by spray coating on the outer periphery of a cylindrical substrate which is made of a polyimide resin and which has a length of 320 mm and a thickness of 50 μm, followed by drying to form a primer layer on the cylindrical substrate. Next, a fluorosilicone (X36-420U from Shin-Etsu Chemical Co., Ltd.) was applied on the primer layer using a blade, followed by heating for 60 minutes at 220° C. to form an elastic layer which has a thickness of 150 μm and a rubber hardness of 40 Hs (shore A) corresponding to about 280 Hv in Vickers hardness).

Next, a fluorocarbon siloxane rubber (SIFEL X-71-6144 from Shin-Etsu Chemical Co., Ltd.) was applied on the elastic layer using a blade to form an adhesive layer.

A particulate alumina having a volume average particle diameter of 3 μm (from Nippon Steel Sumikin Materials Co., Ltd.) was used as the particulate material constituting the release layer. Specifically, by using an applicator illustrated in FIG. 3, a release layer, in which the particulate alumina is arranged along the surface of the adhesive layer as illustrated in FIG. 2A to form a single particle layer, was formed on the adhesive layer. In this regard, a polyurethane rubber blade serving as the pressing member 33 (illustrated in FIG. 3) was pressed at a pressure of 100 mN/cm to scrape off excessive particles.

The substrate bearing thereon the primer layer, the elastic layer, the adhesive layer and the release layer was heated for 30 minutes at 150° C. to fix the particulate alumina to the adhesive layer. Thus, a fixing member 1, in which the particulate alumina is arranged along the surface of the adhesive layer having a thickness of 100 μm as illustrated in FIG. 2A, was prepared.

The thus prepared fixing member 1 was set to the fixing device of a copier MPC 3000 from Ricoh Co., Ltd., which has such a structure as illustrated in FIG. 1A, and 10 solid images were continuously produced. The glossiness (initial glossiness) of the tenth solid image was measured by the below-mentioned method to evaluate the adhesion of the fixing member 1 to a recording medium. In addition, 10 horizontal line images were continuously produced, and the tenth line image was visually observed by the below-mentioned method to determine the offset resistance (i.e., releasability) of the fixing member 1. In this regard, a plain paper MY PAPER from Ricoh Co., Ltd. was used as the recording medium.

The methods for evaluating the initial glossiness and the offset resistance are the following.

### (1) Method for Evaluating Initial Glossiness (i.e., Adhesion of the Fixing Member to Recording Medium)

The glossiness of the fixed solid image at an angle of 60° was measured with a gloss meter PG-1 from Nippon Denshoku Industries Co., Ltd. The glossiness was compared with a reference glossiness (i.e., 14%) so as to be classified into the following four grades.

Grade 1: The glossiness is less than 10% of the reference glossiness. (Worst)
Grade 2: The glossiness is not less than 10% and less than 50% of the reference glossiness.
Grade 3: The glossiness is not less than 50% and less than 100% of the reference glossiness.
Grade 4: The glossiness is not less than 100% of the reference glossiness. (Best)

In this evaluation, only the grade 4 is acceptable.

### (2) Method for Evaluating Offset Resistance (Releasability)

The horizontal line image was visually observed, and the quality of the line image was classified into the following four grades.

Grade 1: The line images of the horizontal line image are seriously peeled (due to transferring of the toner image to the fixing member), and the background of the horizontal line image is seriously soiled (due to re-transferring of the toner image to the recording medium). (Worst)
Grade 2: The line images of the horizontal line image are peeled and the background of the horizontal line image is soiled with the toner to an extent such that the image is considered to be an abnormal image.
Grade 3: The line images of the horizontal line image are slightly peeled and the background of the horizontal line image is slightly soiled with the toner to an extent such that the image is not considered to be an abnormal image.
Grade 4: The line images of the horizontal line image are not peeled and the background of the horizontal line image is not soiled with the toner. (Best)

In this evaluation, the grades 3 and 4 are acceptable.

In addition, the below-mentioned tacking test was performed on the fixing member 1 to evaluate the strength of the release layer.

### (3) Method of the Tacking Test (Method for Determining Release of Particulate Material)

A cut piece of the fixing member 1 was set on a tacking tester TAC-1000 from RHESCA COMPANY LIMITED, and a magenta solid image was contacted with the cut piece under the following conditions.

Weight of the magenta solid image (alternative property of image density): 0.43 mg/cm²

Contact pressure of magenta solid image per unit area: 40 N/cm²

Temperature: 150° C.

Pressing time: 0.05 seconds

After the test, the magenta solid image was peeled from the cut piece, and the cut piece was observed with a scanning electron microscope (SEM) to determine whether or not particles of the release layer are released from the adhesive layer.

### Example 2

The procedure for preparation and evaluation of the fixing member 1 was repeated except that the fluorocarbon siloxane rubber used for the adhesive layer was replaced with another fluorocarbon siloxane rubber (SIFEL 3590-N from Shin-Etsu Chemical Co., Ltd.) to prepare a fixing member 2.

### Example 3

The procedure for preparation and evaluation of the fixing member 1 was repeated except that the fluorocarbon siloxane rubber used for the adhesive layer was replaced with another fluorocarbon siloxane rubber (SIFEL 2611 from Shin-Etsu Chemical Co., Ltd.) to prepare a fixing member 3.

### Example 4

The procedure for preparation and evaluation of the fixing member 1 was repeated except that the particulate alumina used for the release layer was replaced with a particulate calcium carbonate from NEW LIME, which has a volume average particle diameter of 8 μm, to prepare a fixing member 4.

### Example 5

The procedure for preparation and evaluation of the fixing member 1 was repeated except that the particulate alumina used for the release layer was replaced with a particulate titania having a volume average particle diameter of 3 μm to prepare a fixing member 5.

### Example 6

The procedure for preparation and evaluation of the fixing member 1 was repeated except that the particulate alumina used for the release layer was replaced with a particulate manganese oxide having a volume average particle diameter of 10 μm to prepare a fixing member 6.

### Example 7

The procedure for preparation and evaluation of the fixing member 1 was repeated except that the particulate alumina used for the release layer was replaced with a particulate polyimide resin, UIP-S from Ube Industries, Ltd., which has a volume average particle diameter of 10 μm, to prepare a fixing member 7.

### Example 8

The procedure for preparation and evaluation of the fixing member 1 was repeated except that the particulate alumina used for the release layer was replaced with a particulate glass, EMB-10 from Potters-Ballotini Co., Ltd., which has a volume average particle diameter of 5 μm, to prepare a fixing member 8.

### Example 9

The procedure for preparation and evaluation of the fixing member 1 was repeated except that the particulate alumina used for the release layer was replaced with a particulate perfluoroalkoxyalkane resin (PFA), MP-102 from Du Pont Mitsui Fluorochemicals Co., Ltd., which has a volume average particle diameter of 3.0 μm, to prepare a fixing member 9.

### Example 10

The procedure for preparation and evaluation of the fixing member 1 was repeated except that the particulate alumina used for the release layer was replaced with a particulate silicone resin, TOSPEARL 120 from Momentive Performance Materials Inc., which has a volume average particle diameter of 2.0 μm, to prepare a fixing member 10.

### Comparative Example 1

A silicone (X-34-387 from Shin-Etsu Chemical Co., Ltd.) was applied by a blade on the outer periphery of a cylindrical substrate which is made of a polyimide resin and which has a length of 320 mm and a thickness of 50 μm, and the applied silicone was heated for 30 minutes at 150° C., followed by secondary vulcanization for 4 hours at 200° C. to prepare a silicone resin layer with a rubber hardness of 41 Hs (shore A) and a thickness of 200 μm on the cylindrical substrate. Thus, a fixing member 11 was prepared.

### Comparative Example 2

The procedure for preparation and evaluation of the fixing member 1 was repeated except that the adhesive layer and the particle layer (release layer) were not formed, and the following release layer was formed on the elastic layer.

Specifically, a primer (PR-990CL from Du Pont Mitsui Fluorochemicals Co., Ltd.) was applied on the elastic layer by spray coating, followed by drying for 30 minutes at 150° C. to form a primer layer with a thickness of 4 μm on the elastic layer.

Next, the following components were mixed to prepare a release layer composition.

| | |
|---|---|
| Perfluoroalkoxyalkane resin (PFA) | 1 part |
| (PFA-950HP PLUS from Du Pont Mitsui Fluorochemicals | |
| Co., Ltd., having an average particle diameter of | |
| 10 μm and a melt flow rate (MFR) (defined in JIS | |
| K 7210) of 2 g/10 min measured at 372° C. under | |
| a load of 5 kgf (49N)) | |
| Perfluoroalkoxyalkane resin (PFA) | 1 part |
| (PFA-945HP PLUS from Du Pont Mitsui Fluorochemicals | |
| Co., Ltd., having an average particle diameter of | |
| 0.1 μm and a melt flow rate (MFR) (defined in JIS | |
| K 7210) of 7 g/10 min measured at 372° C. under | |
| a load of 5 kgf (49N)) | |

The release layer composition was applied to the primer layer by spray coating to prepare a layer with a thickness of 30 μm, followed by heating (calcination) for 30 minutes at 340° C. to melt the PFA particles to prepare a release layer. Thus, a fixing member 12 was prepared.

### Comparative Example 3

Initially, a primer for silicone (PRIMER No. 4 from Shin-Etsu Chemical Co., Ltd.) was applied by spray coating on the outer periphery of a cylindrical substrate which is made of a polyimide resin and which has a length of 320 mm and a thickness of 50 μm, followed by drying to form a primer layer on the cylindrical substrate. Next, a fluorosilicone (X36-420U from Shin-Etsu Chemical Co., Ltd.) was applied on the primer layer using a blade, followed by heating for 60 minutes at 220° C. to form an elastic layer which has a thickness of 150 μm and a rubber hardness of 40 Hs (shore A) corresponding to about 280 Hv in Vickers hardness).

A particulate silicone resin, TOSPEARL 120 from Momentive Performance Materials Inc., which has a volume average particle diameter of 2.0 μm, was used as the particulate material constituting the release layer. Specifically, by using an applicator illustrated in FIG. 3, a release layer, in which the particulate silicone resin is arranged along the surface of the adhesive layer as illustrated in FIG. 2A to form a single particle layer, was formed on the elastic layer. In this regard, a polyurethane rubber blade serving as the pressing member 33 was pressed at a pressure of 100 mN/cm to scrape off excessive particles.

The substrate bearing thereon the primer layer, the elastic layer, and the release layer was heated for 10 minutes at 150° C. to fix the particulate silicone resin to the elastic layer. Thus, a fixing member 13, in which the particulate silicone resin is arranged along the surface of the elastic layer having a thickness of 150 μm as illustrated in FIG. 2A, was prepared.

The evaluation results of the fixing members 1-13 are shown in Table 1 below.

TABLE 1

| | | | Embedding | | | |
|---|---|---|---|---|---|---|
| | Presence or | | rate of | | Offset | Release of |
| | absence of | Material of | particulate | Glossiness | resistance | particulate |
| | adhesive layer | release layer | material | (grade) | (grade) | material |
| Ex. 1 | Presence | Particulate | 0.58 | 4 | 4 | No |
| | | alumina | | | | |
| Ex. 2 | Presence | Particulate | 0.61 | 4 | 4 | No |
| | | alumina | | | | |
| Ex. 3 | Presence | Particulate | 0.59 | 4 | 4 | No |
| | | alumina | | | | |
| Ex. 4 | Presence | Particulate | 0.65 | 4 | 4 | No |
| | | calcium | | | | |
| | | carbonate | | | | |
| Ex. 5 | Presence | Particulate | 0.55 | 4 | 4 | No |
| | | titania | | | | |
| Ex. 6 | Presence | Particulate | 0.53 | 4 | 3 | No |
| | | manganese | | | | |
| | | oxide | | | | |
| Ex. 7 | Presence | Particulate | 0.59 | 4 | 3 | No |
| | | polyimide | | | | |
| Ex. 8 | Presence | Particulate | 0.61 | 4 | 3 | No |
| | | glass | | | | |
| Ex. 9 | Presence | Particulate | 0.52 | 4 | 4 | No |
| | | PFA resin | | | | |
| Ex. 10 | Presence | Particulate | 0.57 | 4 | 4 | No |
| | | silicone | | | | |
| | | resin | | | | |
| Comp. Ex. | Absence | No release | — | 2 | 1 | — |
| 1 | | layer | | | | |
| Comp. Ex. | Absence | PFA thin | — | 3 | 4 | — |
| 2 | | film | | | | |
| Comp. Ex. | Absence | Particulate | 0.31 | 4 | 4 | Yes |
| 3 | | silicone | | | | |
| | | resin | | | | |

It is clear from Table 1 that the fixing members 1-10 of Examples 1-10 have a good combination of adhesion and releasability (i.e., offset resistance). In contrast, at least one of adhesion and releasability of the fixing members 11 and 12 of Comparative Examples 1 and 2 is not acceptable. The fixing member 13 of Comparative Example 3 has a drawback in that the particulate material constituting the release layer is released from the fixing member.

As mentioned above, by forming a particle layer, in which a particulate material is arranged along the surface a fixing member, as a release layer of the fixing member, the fixing member can have a good combination of flexibility and adhesion (i.e., ability to be contacted with recessed portions of a recording medium such as paper). As a result, toner particles present on recessed portions of a recording medium (such as paper) can be satisfactorily melted and fixed to the recording medium by the fixing member, thereby making it possible to produce high quality images with high glossiness. Further, since the amount of residual melted toner remaining on the fixing member can be reduced, high quality images without abnormal images (such as offset images) can be produced.

Furthermore, by forming an adhesive layer between the release layer and the elastic layer, release of the particulate material of the release layer is hardly caused even when a strong stress is applied to the release layer, and therefore the fixing operation can be securely performed over a long period of time, thereby making it possible to produce high quality images over a long period of time.

Additional modifications and variations of the present invention are possible in light of the above teachings. It is therefore to be understood that within the scope of the appended claims the invention may be practiced other than as specifically described herein.

What is claimed is:

1. A fixing member having a roller shape or a seamless belt shape for fixing toner, comprising:
an elastic layer;
an adhesive layer located overlying the elastic layer; and
a release layer including a particulate material, wherein the particulate material is arranged along a surface of the adhesive layer.

2. The fixing member according to claim 1, wherein the adhesive layer is an elastic material layer having heat resistance of not lower than 200° C.

3. The fixing member according to claim 1, wherein the adhesive layer includes a fluorocarbon siloxane rubber.

4. The fixing member according to claim 1, wherein the elastic layer is a silicone rubber layer.

5. The fixing member according to claim 1, wherein the particulate material of the release layer is embedded into the elastic layer at an embedding rate of greater than 0.5 and not greater than 0.9.

6. A fixing device comprising:
the fixing member according to claim 1; and
a counter member opposed to the fixing member,
wherein the fixing device applies heat and pressure to a recording medium, which bears a toner image thereon and which passes between the fixing member and the counter member, to fix the toner image to the recording medium.

7. An image forming apparatus comprising:
an electrostatic latent image carrier;
an electrostatic latent image forming device to form an electrostatic latent image on the electrostatic latent image carrier;
a developing device to develop the electrostatic latent image with a developer including a toner to form a toner image on the electrostatic latent image carrier;
a transferring device to transfer the toner image onto a recording medium; and
the fixing device according to claim 6 to fix the toner image to the recording medium.
